(19) United States
(12) Patent Application Publication
(10) Pub. No.: US 2009/0022125 A1
(43) Pub. Date: Jan. 22, 2009

(54) DIRECT LINK TEARDOWN PROCEDURE IN TUNNELED DIRECT LINK SETUP (TDLS) WIRELESS NETWORK AND STATION SUPPORTING THE SAME

(75) Inventor: Yong Ho Seok, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG Electronics Inc.

(21) Appl. No.: 12/171,182

(22) Filed: Jul. 10, 2008

(30) Foreign Application Priority Data
Jul. 11, 2007 (KR) 10-2007-0069510

(51) Int. Cl. H04Q 7/24

(52) U.S. Cl. 370/338

(57) ABSTRACT

Provided are a direct link teardown procedure in a TDLS (Tunneled Direct Link Setup) wireless network and a station supporting the direct link teardown procedure. In the direct link teardown procedure, an initiating station of the teardown procedure transmits a TDLS teardown request message to the peer station of the direct link. The initiating station receives a TDLS teardown response message in response to the TDLS teardown request message from the peer station. Then, the initiating station disables its direct Rx path and destroys the security parameters relevant to the direct link upon receipt of the TDLS teardown response message.

### CROSS-REFERENCE TO RELATED PATENT APPLICATIONS

This application claims the benefit of Korean Patent Application No. 10-2007-0069510 filed on Jul. 11, 2007 in the Korean Intellectual Property Office, the disclosure of which is incorporated herein in its entirety by reference.

### BACKGROUND OF THE INVENTION

1. Field of the Invention

The present invention relates to a wireless local access network (WLAN), and more particularly, to a direct link teardown procedure in a TDLS (Tunneled Direct Link Setup) wireless network and a station supporting the direct link teardown procedure.

2. Description of the Related Art

With the development of information communication technology, a variety of wireless communication technology has been developed. A wireless LAN (WLAN) permits a wireless access to its local network or Internet in specific service areas such as home or companies or air planes by the use of portable terminals such as a personal digital assistant (PDA), a laptop computer, and a portable multimedia player (PMP) on the basis of radio communication technology.

These days, thanks to the increased availability of the WLANs, portable terminal users such as laptop computer users are able to perform their tasks with increased mobility. For example, a user can take his laptop computer from his desk into a conference room to attend a meeting and can still have access to his local network to retrieve data or have access to the Internet via one or more modems or gateways present on the local network without being tethered by a wired connection. Similarly, business travelers commonly use their portable terminals to gain access to their email accounts, to check if there is any unread email, and to read and send email.

In the initial WLAN technology, a data rate of 1 to 2 Mbps was supported by the use of frequency hopping, spread spectrum, and infrared communication using a frequency of 2.4 GHz. In recent years, with the development of the wireless communication technology, 54 Mbps in maximum can be supported by applying the Orthogonal Frequency Division Multiplex (OFDM) technology, etc. to the WLAN. In addition, the IEEE 802.11 has developed or is developing wireless communication technology for improvement in quality of service (QoS), compatibility of an access point (AP) protocol, security enhancement, wireless resource measurement, wireless access in vehicular environment, fast roaming, mesh network, inter-working with external networks, wireless network management, and the like.

In the IEEE 802.11, a Basic Service Set (BSS) means a set of stations (STAs) successfully synchronized with each other. A Basic Service Area (BSA) means an area including members of the BSS. The BSA can vary depending on propagation characteristics of a wireless medium and thus the boundary thereof is not clear. The BSS can be basically classified into two kinds of an independent BSS (IBSS) and an infra-structured BSS. The former means a BSS that constitutes a self-contained network and that is not permitted to access a Distribution System (DS). The latter means a BSS that includes one or more Access Points (APs) and a distribution system and that uses the APs in all the communication processes including communications between the Non-AP stations.

In the initial WLAN communication procedure, it was required that data is necessarily transmitted through the AP in the infra-structured BSS. That is, the direct transmission of data between non-AP stations (non-AP STAs) is not allowed in the infra-structured BSS. In recent years, a direct link setup (DLS) between the non-AP STAs supporting the Quality of Service (QoS) has been introduced to improve the efficiency of wireless communications. Accordingly, in the BSS supporting the QoS, that is, in the QBSS including QoS STAs (QSTA) and QoS APs (QAP), the non-AP STAs can set up a direct link and directly communicate with each other through the direct link.

### SUMMARY OF THE INVENTION

As described above, the existing DLS procedure is based on the premise that the BSS is a QBSS which is a BSS supporting the QoS. In the QBSS, the AP as well as the non-AP STA is a QAP which is an AP supporting the QoS. In the most WLAN environments currently used (for example, WLAN environments in accordance with the IEEE 802.11a/b/g), the non-AP STAs are QSTAs supporting the QoS, but the APs are legacy APs not supporting the QoS. As a result, in the WLAN environments currently used, there exists such a limitation that even a QSTA cannot utilize the DLS service.

A TDLS (Tunneled Direct Link Setup) is a wireless communication protocol newly suggested to overcome such a limitation regarding the existing DLS procedure. The TDLS allows the QSTAs to set up a direct link in the currently used WLAN environments in accordance with the IEEE 802.11a/b/g. Accordingly, the TDLS defines procedures of allowing the QSTAs to set up a direct link even in the BSS managed by the legacy AP. Hereinafter, a wireless network supporting the TDLS procedure is referred to as a TDLS wireless network.

On the other hand, in order to actually apply the TDLS to a WLAN, all procedures associated with the TDLS such as a procedure of transmitting data through a set-up direct link, a procedure of selecting a relation or link between a direct link and an existing link (AP link) via an AP, a procedure of managing a power supply of the QSTA, and a procedure of tearing down a set-up direct link, in addition to a procedure of setting up a direct link, should be specifically defined. However, such procedures associated with the TDLS, particularly, the procedure of tearing down the set-up direct link, are not defined specifically and in details.

A goal of the invention is to provide a procedure of tearing down a set-up direct link in a TDLS wireless network and a station supporting the procedure.

Another goal of the invention is to provide a method capable of enhancing the reliability of the direct link teardown procedure in the TDLS wireless network.

According to an aspect of the invention, there is provided a procedure for tearing down a direct link in a Tunneled Direct Link Setup (TDLS) wireless network, the procedure comprising: transmitting a TDLS teardown request message to the peer station of the direct link; receiving a TDLS teardown response message in response to the TDLS teardown request message from the peer station; and disabling its direct Rx path and destroying the security parameters relevant to the direct link upon receipt of the TDLS teardown response message.

According to another aspect of the invention, there is provided a procedure for tearing down a direct link in a Tunneled Direct Link Setup (TDLS) wireless network, the procedure comprising: receiving a TDLS teardown request message from the peer station of the direct link; disabling its direct Rx and Tx paths and destroying security parameters relevant to the direct link upon the receipt of the TDLS teardown request message; and transmitting a TDLS teardown response message in response to the TDLS teardown request message to the peer station.

According to further another aspect of the invention, there is provided a procedure in a Tunneled Direct Link Setup (TDLS) wireless network, the procedure comprising: establishing a direct link with a peer station; transmitting a TDLS teardown request message to the peer station; and releasing the direct link in case of receiving a response message in response to the TDLS teardown request message from the peer station.

According to still further another aspect of the invention, there is provided a station for supporting a Tunneled Direct Link Setup (TDLS) procedure in a wireless local access network, the station comprising: a processor configured to generate and process frames; and a transceiver operably connected to the processor and configured to transmit and receive the frames for the processor, wherein the processor is configured to generate a TDLS teardown request message encapsulated in data frames and forward the generated TDLS teardown request message to the transceiver; wherein the transceiver is configured to transmit the TDLS teardown request message to the peer station, to receive a TDLS teardown response message from the peer station in response to the TDLS teardown request message, and to forward the received TDLS teardown response message to the processor; and wherein the processor is configured to disable its direct Rx path and to destroy the security parameters relevant to the direct link upon receipt of the TDLS teardown response message.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a format of a medium access control (MAC) frame associated with a TDLS procedure.

FIG. 2 is a diagram illustrating types of a TDLS frame and values corresponding to the types.

FIG. 3 is a diagram illustrating a flow of messages in the TDLS procedure.

FIG. 4 is a table illustrating information included in a TDLS request frame.

FIG. 5 is a table illustrating information included in a TDLS response frame.

FIG. 6 is a diagram illustrating a flow of messages in a direct link teardown procedure according to a first embodiment of the invention.

FIG. 7 is a diagram illustrating a flow of messages in a direct link teardown procedure according to a second embodiment of the invention.

FIG. 8 is a flow diagram illustrating the direct link teardown procedure according to the second embodiment of the invention.

FIG. 9 is a flow diagram illustrating a direct link teardown procedure according to a third embodiment of the invention.

FIG. 10 is a flow diagram illustrating the direct link teardown procedure according to the third embodiment of the invention.

### DETAILED DESCRIPTION OF THE INVENTION

Hereinafter, embodiments of the invention will be described in detail with reference to the accompanying drawings.

In a TDLS wireless network to which embodiments of the invention can be applied, even non-AP QSTAs (hereinafter, simply referred to as “QSTA”) associated with a legacy AP not supporting the QoS can set up a direct link and tear down the set-up direct link. In order to set up a direct link with another QSTA or tear down a direct link with a peer QSTA, a QSTA should be able to transmit and receive management action frames for setting up and tearing down a direct link through a legacy AP. However, the legacy AP cannot directly participate in two QSTAs setting up a direct link or tearing down the set-up direct link in accordance with the existing DLS procedure.

One method of solving such a problem is to encapsulate the management action frames associated with a direct link in the form of a data frame and to transmit the encapsulated data frame to a peer QSTA. In this case, similarly to the transmission of a data frame between two non-AP STAs, the legacy AP performs only a function of relaying the transmission of the management action frame. As a result, the legacy AP does not participate in procedures of setting up, managing, and tearing down a TDLS link. The embodiments described later can be effectively applied to a TDLS wireless network in which management action frames for setting up, tearing down, and managing a TDLS link are encapsulated in the form of frames and transmitted and received through an AP. Here, the AP is not limited to legacy AP, but may be a QAP supporting the TDLS.

Among elements constructing the TDLS wireless network system, a non-AP STA is a device including a medium access control (MAC) complying with the IEEE 802.11 standard and a physical layer interface for a wireless medium. The non-AP STA is a wireless device, not an AP, and may be called a wireless transmitting/receiving unit (WTRU), a user equipment (UE), a mobile station (MS), or a mobile subscriber unit. The non-AP STA supporting the quality of service (QoS) is simply referred to as a non-AP QSTA.

The non-AP STA includes a processor and a transceiver and may further include a user interface and a display unit in general. The processor is a functional unit designed to generate a frame to be transmitted through a wireless network or to process the frame received through the wireless network, and serves to control stations and to process various signals input by a user. A transceiver is functionally connected to the processor and is a unit designed to transmit and receive a frame through the wireless network for the stations.

The AP is a functional entity having a function as a wireless device and providing access to a distribution system (DS) through a wireless medium for the associated stations. The AP may be a legacy AP not supporting the QoS, but is not limited to the legacy AP. The AP may be called a convergence controller, a base station (BS), a node-B, or a site controller.

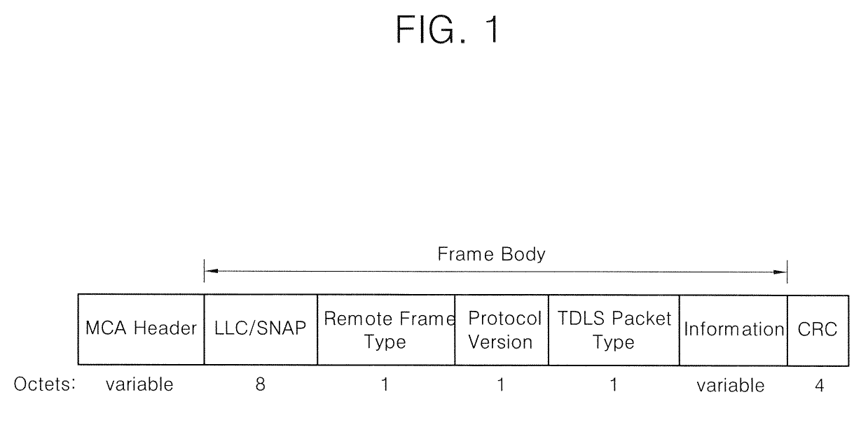

FIG. 1 is a diagram illustrating a format of a medium access control (MAC) frame (hereinafter, referred to as TDLS frame”) which a first QSTA transmits and receives to and from an opposite QSTA (or a peer QSTA) through an AP in the TDLS wireless network. Referring to FIG. 1, the TDLS frame includes a MAC header field, a logical link control (LLC)/sub-network access protocol (SNAP) field, a remote frame type field, a TDLS packet type field, an information field, and a cyclic redundancy code (CRC) field. The TDLS frame may further include a protocol version field.

The MAC header field includes information common to almost all the types of frames. For example, the MAC header field can include a frame control field, a duration/ID field, plural address fields Address1, Address2, Address3, and Address4, a sequence control field, and/or a QoS control field.

The frame control field includes a protocol version subfield, a type and subtype subfield for identifying a function of a frame, a more fragment field indicating whether a more fragment of a subsequent current MSDU or MMPDU exists, a retry subfield indicating whether the frame is a frame to be retransmitted, and a power management subfield indicating whether it works in a power save mode. The power management subfield of the frame control field indicates a mode in which the STA works after the exchange of a series of frames is successfully completed. For example, when the power management subfield is set to “0”, it indicates that the STA transmitting the frame works in an active mode. When the power management subfield is set to “1”, it indicates that the transmitting STA works in a peer power save mode.

The QoS control field is designed to distinguish a traffic category (TC) or a traffic stream (TS) to which the frame belongs with various different QoS information on the frame which varies depending on the frame type and subtype. The QoS control field may be included in all the TDLS frames in which the QoS subfield of the subtype field thereof is set to “1”. The QoS control field includes 5 subfields and utilization examples and usable layouts of the subfields are shown in Table 1.

TABLE 1

| Applicable Frame | Bits | | | | |
|---|---|---|---|---|---|
| (sub) Types | 0-3 | Bit 4 | Bits 5-6 | Bit 7 | Bits 8-15 |
| QoS (+)CF-Poll frames sent by HC | TID | EOSP | Ack Policy | Reserved | TXOP limit |
| QoS Data, QoS Null, and QoS | TID | EOSP | Ack Policy | Reserved | AP PS Buffer State |
| Datal+CF-Ack frames sent by HC | | | | | |
| QoS data frames sent by non-AP to | TID | 0 | Ack Policy | Reserved | TXOP Duration Requested |
| an AP | TID | 1 | Ack Policy | Reserved | Queue Size |
| QoS Data, QoS Null, and QoS | TID | EOSP | Ack Policy | Reserved | Reserved |
| Data+CF-Ack frames sent over the | | | | | |
| direct link | | | | | |

[symbol]

LLC/SNAP header. The remote frame type field can be set to a value (for example, “2”) indicating that it is a TDLS frame. The protocol version field can be set to a value indicating a protocol version of a message to be transmitted and received.

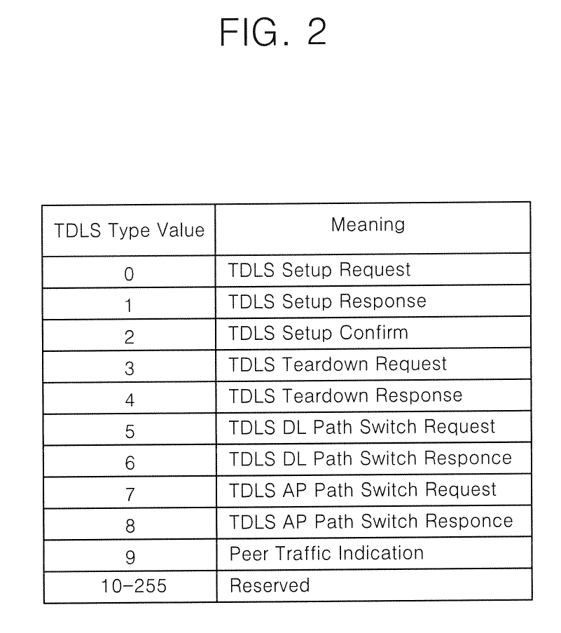

The TDLS packet type field is set to a value specifying the type of the TDLS frame. Examples of the types of the TDLS frames and values corresponding thereto are shown in FIG. 2. Referring to FIG. 2, the TDLS frame includes a TDLS setup request frame, a TDLS setup response frame, a TDLS setup confirmation frame, a TDLS teardown request frame, and a TDLS teardown response frame.

The information field of the TDLS frame includes a variety of information individually specified depending on the types of the TDLS frame, and the information is different depending on the TDLS types. The error correction field (CRC) includes additional information for correcting an error of the frame.

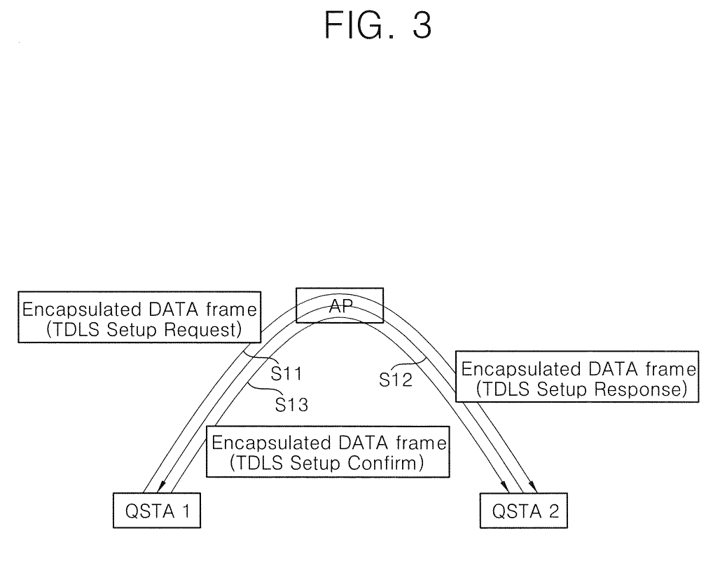

FIG. 3 is a diagram illustrating a flow of messages in a direct link setup procedure in a TDLS wireless network according to an embodiment of the invention. The TDLS wireless network system includes two non-AP QSTAs (hereinafter, simply referred to as “QSTA”) and an AP. FIG. 3 exemplarily shows a direct link setup procedure in a TDLS wireless network, which is performed through a 3-way handshake of TDLS management action frames. However, the invention is not limited to the embodiment, but the direct link setup procedure may be performed through a 4-way handshake.

Referring to FIG. 3, a first QSTA intending to set up a direct link transmits a message requesting for setting up the direct link, for example, a TDLS setup request frame, to a second QSTA through the AP (S11). In the TDLS setup request frame, the TDLS packet type field of the TDLS frame is set to a value indicating a TDLS setup request. Accordingly, in step S11, the TDLS setup request is encapsulated in the form of a data frame and is transmitted through the AP.

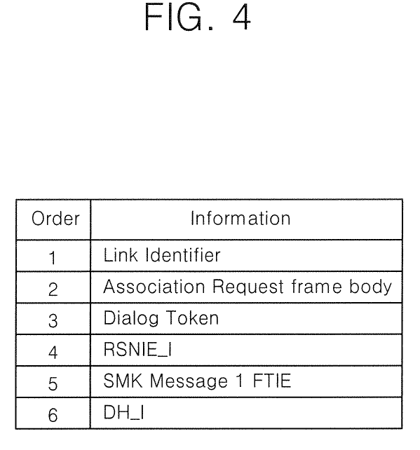

FIG. 4 shows information included in the information field of the TDLS setup request frame (the information field of the TDLS frame shown in FIG. 1). Referring to FIG. 4, the information field of the TDLS setup request frame includes a link identifier information, association request frame body information, and dialog token information. Although not shown in FIG. 4, the information field of the TDLS setup request frame may further include capability information or extended capability information.

Referring to FIG. 3, the second QSTA having received the TDLS setup request frame transmits a TDLS setup response frame to the first QSTA through the AP in response to the TDLS setup request frame. In this case, in the TDLS setup response frame, the TDLS packet type field of the TDLS frame shown in FIG. 1 is set to a value indicating a TDLS setup response. Accordingly, the TDLS setup response frame is encapsulated in the form of a data frame and is transmitted to the first QSTA through the AP.

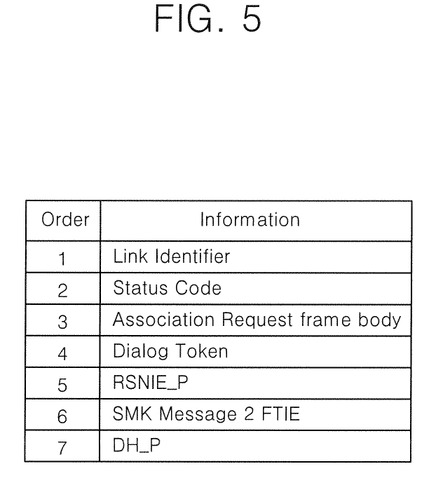

FIG. 5 shows information included in the information field of the TDLS setup response frame (the information field of the TDLS frame shown in FIG. 1). Referring to FIG. 5, the information field of the TDLS setup response frame includes link identifier information, status code information, association request frame body information, and dialog token information. Similarly to the information field of the TDLS setup request frame, the information field of the TDLS setup response frame may further include an information element indicating whether the STA having transmitted the TDLS setup response frame supports a peer PSM AP mode and/or a peer PSM client mode, such as an extended capability information element.

Referring to FIG. 3 again, the first QSTA transmits a TDLS setup confirmation frame to the second QSTA through the AP in response to the received TDLS setup response frame (S13). In the TDLS setup confirmation frame, the TDLS packet type field of the TDLS frame shown in FIG. 1 is set to a value indicating a TDLS setup confirmation, and the TDLS setup confirmation frame is encapsulated in the form of a data frame and is transmitted to the second QSTA through the AP. In the TDLS setup procedure, since the management action frames are encapsulated in the form of a data frame and is transmitted without the direct participation of the AP therein, the management action frames may be lost during the transmission thereof. Accordingly, in the TDLS setup procedure, an initiating QSTA (first QSTA) transmits the TDLS setup confirmation frame in response to the TDLS setup response frame from the peer QSTA (second QSTA).

When the TDLS setup request frame, the TDLS setup response frame, and the TDLS setup confirmation frame have been exchanged between the first QSTA and the second QSTA, a TDLS link is set up between the first QSTA and the second QSTA. When the direct link is set up between two QSTAs, the first QSTA and the second QSTA can transmit and receive data through the direct link, not via the AP. Similarly to the situation before the direct link is not set up, the first QSTA and the second QSTA having set up the direct link can also transmit and receive data through the AP.

Any one QSTA having set up the direct link can enter a power save mode (PSM) with the direct link maintained. In this case, the QSTA is a STA supporting a peer PSM (PPSM) client mode and the peer QSTA is a STA supporting a PPSM AP mode. When one QSTA intends to enter the PSM, the QSTA may switch the data receiving path to the AP path, or may stop the reception of data through a receiving path using the direct link (direct Rx path) but may maintain the direct link. In the latter, the QSTA can enter the PPSM client mode after transmitting a frame of which a power management bit has been set to the peer QSTA.

A direct link teardown procedure according to an embodiment of the invention in the TDLS wireless network including a first QSTA and a second QSTA having set up a direct link therebetween will be described now.

As the direct link teardown procedure applicable to the TDLS wireless network, it can be considered that the direct link teardown procedure in a QBSS defined in the IEEE 802.11e is used without any change. In this case, one (QSTA initiating the direct link teardown) of two QSTAs having set up the direct link transmits a DLS teardown action frame to a QAP and the QAP transmits the DLS teardown action frame to a peer QSTA, that is, a recipient QSTA. Here, as soon as the QAP successfully receives the DLS teardown action frame, the initiating QSTA tears down the direction link. As soon as the peer QSTA receives the DLS teardown action frame from the QAP, it tears down the direct link. As a result, the direct link between two QSTAs is completely torn down.

In the existing direct link teardown procedure, the QAP takes charge of the exchange of the management action frames for tearing down the direct link of the initiating QSTA and the peer QSTA. The QAP supports the DLS and can guarantee the successful transmission of the management action frames for tearing down the direct link. Accordingly, even when the initiating QSTA lays the charge for tearing down the direct link on the QAP, the problem with reliability does not occur. However, when the direct link teardown procedure is applied to the TDLS wireless network, the problem with reliability may occur.

The TDLS wireless network does not provide reliability to transmission of a data frame. For example, a data frame may not be successfully transmitted to the recipient QSTA due to a queue overflow in the AP or a transmission failure in the AP. As a result, in the TDLS wireless network in which the management action frames are encapsulated in the form of a data frame and transmitted, the successful transmission of the management action frames from the legacy AP to the peer QSTA is not guaranteed. Accordingly, it is not proper that the existing DLS teardown procedure is applied to the TDLS wireless network without any change. Particularly, it is not preferable that the initiating QSTA is allowed to tear down the direct link just after the TDLS teardown request action frame is successfully transmitted to the legacy AP, because the peer STA may not know that the initiating QSTA tears down the direct link and may thus maintain the set-up direct link.

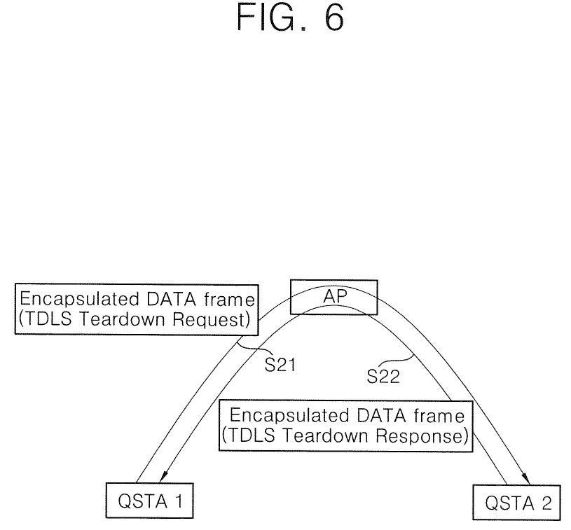

FIG. 6 is a diagram illustrating a flow of messages in the direct link teardown procedure according to an embodiment of the invention.

Referring to FIG. 6, a STA intending to tear down a TDLS link, for example, a first QSTA (QSTA1), transmits a direct link teardown request message, for example, a TDLS teardown request frame, to a second QSTA (QSTA2) as a peer QSTA through an AP (S21). After transmitting the direct link teardown request message, the first QSTA (QSTA1) does not transmit data through the direct link any more. That is, the first QSTA (QSTA1) disables its direct Tx path.

In the TDLS teardown request frame, the TDLS packet type field of the TDLS frame shown in FIG. 1 is set to a value indicating a TDLS teardown request, and the TDLS teardown request frame is encapsulated in the form of a data frame and is transmitted through the AP. The information field of the TDLS teardown request frame may include link identifier information for identifying a direct link, reason code information indicating a reason for generating the TDLS teardown request frame, and dialog token information including a unique value for identifying the exchange of the TDLS teardown request frame and the TDLS teardown response frame.

The second QSTA (QSTA2) having received the TDLS teardown request frame transmits a direct link teardown response message, that is, a TDLS teardown response frame, to the first QSTA (QSTA1) through the AP in response to the TDLS teardown request frame (S22). In this case, on receiving the TDLS teardown request frame, the second QSTA disables the direct Rx and Tx paths, destroys the related security parameters, and then transmits the TDLS teardown response frame. Then, on receiving the direct link teardown response message, the first QSTA (QSTA1) disables the direct Rx path and destroys the related security parameters.

In the TDLS teardown response frame, the TDLS packet type field of the TDLS frame shown in FIG. 1 is set to a value indicating a TDLS teardown response, and the TDLS teardown response frame is encapsulated in the form of a data frame and is transmitted through the AP. The information field of the TDLS teardown response frame may include link identifier information for identifying a direct link and dialog token information including the same value as the dialog token information of the received TDLS teardown request frame.

According to the above-mentioned embodiment of the invention, the QSTA initiating the direct link teardown procedure completely tears down its direct link after receiving a response message to the direct link teardown request message having been transmitted from the peer QSTA. Accordingly, since it is guaranteed that the initiating QSTA and the peer QSTA both tear down the direct link, it is possible to enhance the reliability of the direct link teardown procedure and to prevent only the initiating QSTA from tearing down the direct link.

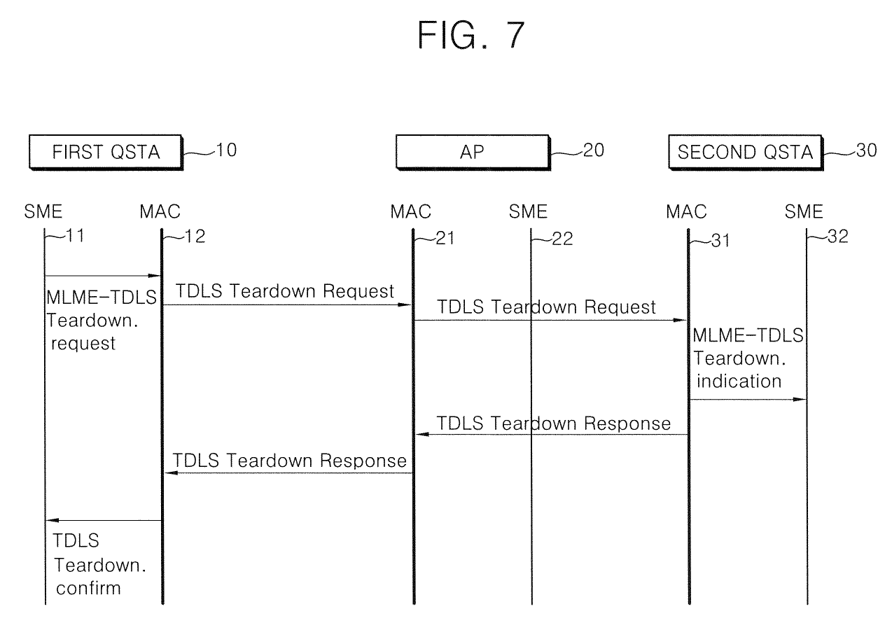

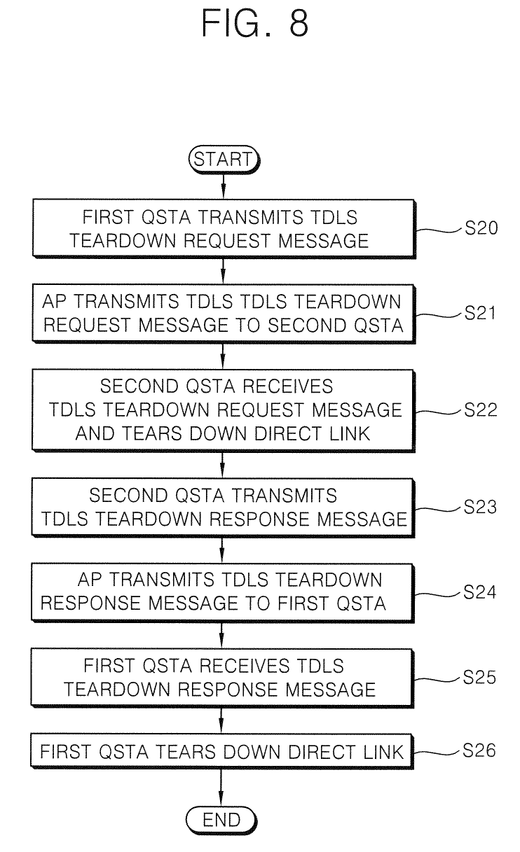

FIGS. 7 and 8 are a message flowchart and an operation flowchart illustrating a direct link teardown procedure in a TDLS wireless network according to a second embodiment of the invention, respectively. As shown in FIG. 7, the TDLS wireless network system includes a first QSTA 10, a second QSTA 30, and an AP 20 as wireless devices. The first QSTA 10, the second QSTA 30, and the AP 20 include MAC layer management entities (MLME) 12, 21, and 31, and system management entities (SME) 11, 22, and 32.

Referring to FIGS. 7 and 8, first, the system management entity 11 of the first QSTA 10 generates a signal of MLME-DLS teardown.request for tearing down a direct link and sends the generated signal to the MAC 12 of the first QSTA 10. Then, the MAC 12 of the first QSTA 10 generates a direct link teardown request message or a TDLS teardown action frame corresponding to the signal of MLME-DLS teardown.request and transmits the generated message or frame to the MAC 21 of the AP 20. The AP 20 transmits the received direct link teardown request message to the second QSTA 30 (S21).

In this case, when the AP 20 is a legacy AP not supporting the QoS, the direct link teardown request message is encapsulated in the form of a data message and is transmitted to the second QSTA 30 through the AP 20. The first QSTA 10 having transmitted the direct link teardown request message does not completely tear down the set-up direct link and waits for a predetermined period of time, until receiving a response message to the direct link teardown request message, for example, a direct link teardown response message, a confirmation message, or a TDLS teardown action frame, from the second QSTA 30. However, after transmitting the direct link teardown request message, the first QSTA 10 may not transmit any data through the direct link.

Then, the second QSTA 30 having received the direct link teardown request message through the AP 20 generates a signal of MLME-TDLS teardown.indication and sends the generated signal to the system management entity 32. The system management entity 32 of the second QSTA 30 having received the signal of MLME-TDLS teardown.indication tears down the direct link set up with the first QSTA 10 (S22). The direct link teardown may disable the direct Rx and Tx paths and may remove the security parameters related to the direct link. The direct link teardown of the second QSTA 30 may be performed after or before transmitting the direct link teardown response message.

The MAC 31 of the second QSTA 30 transmits a direct link teardown response message to the AP 20 in response to the received direct link teardown request message (S23). The AP transmits the direct link teardown response message to the first QSTA 10 (S24). At this time, the direct link teardown response message is encapsulated in the form of a data message and is transmitted to the first QSTA 10 through the AP 20.

The MAC 12 of the first QSTA 10 having received the direct link teardown response message generates a signal of TDLS teardown.confirm and sends the generated signal to the system management entity 11 and the system management entity 11 having received the signal of TDLS teardown.confirm tears down the direct link with the second QSTA 30 (S25 and S26). Here, the direct link teardown process may include disabling its direct Rx path and removing the related security parameters.

In this embodiment, the initiating QSTA having initiated the direct link teardown procedure tears down its direct link after receiving the response message from the peer QSTA. Accordingly, according to this embodiment, it is possible to prevent only the initiating QSTA from tearing down the direct link due to the transmission failure of the TDLS teardown request message which is encapsulated in the form of a data frame and is then transmitted and to enhance the reliability of the direct link teardown procedure.

On the other hand, the system management entity 11 of the first QSTA 10 may not receive the signal of TDLS teardown.confirm within the predetermined period of time. In this case, the direct link teardown request message is not successfully transmitted to the peer QSTA, that is, the second QSTA 30. Accordingly, the system management entity 11 of the first QSTA 10 may repeatedly generate a signal of MLME-TDLS teardown.request every predetermined period of time and the first QSTA 10 may repeatedly transmit the direct link teardown request message to the second QSTA 30. The direct link teardown request message is transmitted to the second QSTA 30 through the AP 20.

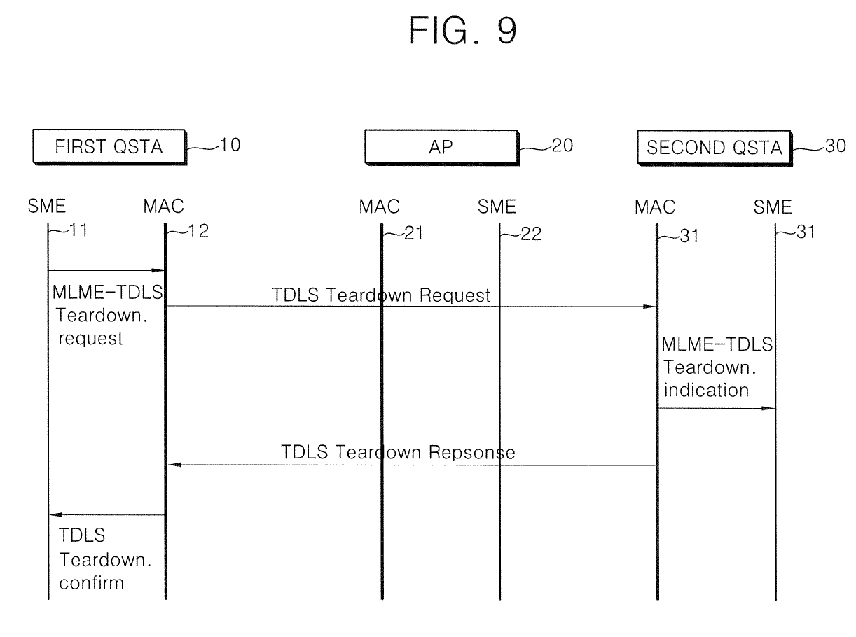

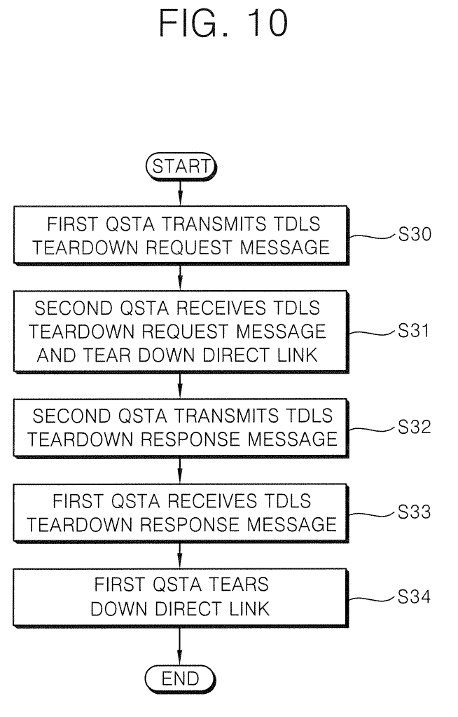

FIGS. 9 and 10 are a message flowchart and an operation flowchart illustrating a direct link teardown procedure in a TDLS wireless network according to a third embodiment of the invention, respectively. As shown in FIG. 9, the TDLS wireless network system includes a first QSTA 10, a second QSTA 30, and an AP 20 as wireless devices. The first QSTA 10, the second QSTA 30, and the AP 20 include MAC layer management entities (MLME) 12, 21, and 31, and system management entities (SME) 11, 22, and 32.

Referring to FIGS. 9 and 10, first, the system management entity 11 of the first QSTA 10 generates a signal of MLME-DLS teardown.request for tearing down a direct link and sends the generated signal to the MAC 12 of the first QSTA 10. Then, the MAC 12 of the first QSTA 10 generates a direct link teardown request message or a TDLS teardown action frame corresponding to the signal of MLME-DLS teardown.request and transmits the generated message or frame to the second QSTA 30 (S30).

In this case, the direct link teardown request message is encapsulated in the form of a data message and is transmitted to the second QSTA 30 through the direct link. The first QSTA 10 having transmitted the direct link teardown request message does not completely tear down the set-up direct link and waits for a predetermined period of time, until receiving a response message to the direct link teardown request message, for example, a direct link teardown response message, a confirmation message, or a TDLS teardown action frame, from the second QSTA 30. However, after transmitting the direct link teardown request message, the first QSTA 10 may not transmit any data through the direct link.

The MAC 31 of the second QSTA 30 having received the direct link teardown request message generates a signal of MLME-TDLS teardown.indication and sends the generated signal to the system management entity 31. The system management entity 32 of the second STA 30 having received the signal of MLME-TDLS teardown.indication signal tears down the direct link set up between the first QSTA 10 and the second QSTA (S31). However, the second QSTA 30 can disable only its direct Rx path.

The MAC 31 of the second QSTA 30 transmits a direct link teardown response message to the first QSTA 10 in response to the received direct link teardown request message (S32). The first QSTA 10 receives the direct link teardown response message (S33). At this time, the direct link teardown response message is encapsulated in the form of a data message and is transmitted to the first QSTA 10 through the direct link.

The MAC 12 of the first QSTA 10 having received the direct link teardown response message generates a signal of TDLS teardown.confirm and sends the generated signal to the system management entity 11 and the system management entity 11 having received the signal of TDLS teardown.confirm tears down the direct link with the second QSTA 30 (S34). Here, the direct link teardown process may include disabling its direct Rx path and removing the related security parameters.

On the other hand, the system management entity 11 of the first QSTA 10 may not receive the signal of TDLS teardown.confirm within the predetermined period of time. In this case, the direct link teardown request message is not successfully transmitted to the peer QSTA, that is, the second QSTA 30. Accordingly, the system management entity 11 of the first QSTA 10 may repeatedly generate the signal of MLME-TDLS teardown.request every predetermined period of time and the first QSTA 10 may repeatedly transmit the direct link teardown request message to the second QSTA 30. The direct link teardown request message is transmitted to the second QSTA 30 through the AP 20.

According to the above-mentioned embodiments of the invention, it is possible to enhance the reliability of the direct link teardown procedure in the TDLS wireless network. Particularly, according to the aspects of the invention, it is possible to prevent a situation that a QSTA tears down a direct link, but the other QSTA does not know the fact and maintains the direct link.

The embodiments described above in detail are only examples explaining the technical spirit of the invention and it should be understood that the technical spirit is not limited to the embodiments. The scope of the invention is defined by the appended claims.

What is claimed is:

1. A procedure for tearing down a direct link in a Tunneled Direct Link Setup (TDLS) wireless network, the procedure comprising:
transmitting a TDLS teardown request message to the peer station of the direct link;
receiving a TDLS teardown response message in response to the TDLS teardown request message from the peer station; and
disabling its direct Rx path and destroying the security parameters relevant to the direct link upon receipt of the TDLS teardown response message.

2. The procedure according to claim 1,
wherein the procedure further comprises disabling its own Tx path after transmitting the TDLS teardown request message.

3. The procedure according to claim 1,
wherein the TDLS teardown request message is transmitted through an access point, and
wherein the TDLS teardown response message is received through the access point.

4. The procedure according to claim 1,
wherein the TDLS teardown request message comprises a link identifier element which identifies the direct link, a reason code element which indicates the reason that the TDLS teardown request frame was generated, and a dialog token element containing a unique value for identifying the exchange of the TDLS teardown request message and the TDLS teardown response message.

5. The procedure according to claim 1,
wherein the TDLS teardown response message comprises a link identifier element which identifies the direct link and a dialog token element which is copied from the TDLS teardown request message.

6. A procedure for tearing down a direct link in a Tunneled Direct Link Setup (TDLS) wireless network, the procedure comprising:
receiving a TDLS teardown request message from the peer station of the direct link;
disabling its direct Rx and Tx paths and destroying security parameters relevant to the direct link upon the receipt of the TDLS teardown request message; and
transmitting a TDLS teardown response message in response to the TDLS teardown request message to the peer station.

7. The procedure according to claim 6,
wherein the peer station disables its own direct Rx path and destroys the security parameters relevant to the direct link upon receipt of the TDLS teardown response message.

8. The procedure according to claim 6,
wherein the TDLS teardown request message is received through an access point, and
wherein the TDLS teardown response message is transmitted through the access point.

9. The procedure according to claim 6,
wherein the TDLS teardown request message comprises a link identifier element which identifies the direct link, a reason code element which indicates the reason that the TDLS teardown request frame was generated, and a dialog token element containing a unique value for identifying the exchange of the TDLS teardown request message and the TDLS teardown response message.

10. The procedure according to claim 6,
wherein the TDLS teardown response message comprises a link identifier element which identifies the direct link and a dialog token element which is copied from the TDLS teardown request message.

11. A procedure for tearing down a direct link in a Tunneled Direct Link Setup (TDLS) wireless network, the procedure comprising:
establishing a direct link with a peer station;
transmitting a TDLS teardown request message to the peer station; and
releasing the direct link in case of receiving a response message in response to the TDLS teardown request message from the peer station.

12. The procedure according to claim 11,
wherein the TDLS teardown request message is transmitted to the peer station through an access point.

13. The procedure according to claim 11,
wherein the TDLS teardown request message is encapsulated in data frames.

14. The procedure according to claim 11,
wherein the peer station releases the direct link in case of receiving the TDLS teardown request message.

15. A station for supporting a Tunneled Direct Link Setup (TDLS) in a wireless local access network, the station comprising:
a processor configured to generate and process frames; and
a transceiver operably connected to the processor and configured to transmit and receive the frames for the processor,
wherein the processor is configured to generate a TDLS teardown request message encapsulated in data frames and forward the generated TDLS teardown request message to the transceiver;
wherein the transceiver is configured to transmit the TDLS teardown request message to the peer station, to receive a TDLS teardown response message from the peer station in response to the TDLS teardown request message, and to forward the received TDLS teardown response message to the processor; and
wherein the processor is configured to disable its direct Rx path and to destroy the security parameters relevant to the direct link upon receipt of the TDLS teardown response message.
